(19) United States
(12) Patent Application Publication
(10) Pub. No.: US 2024/0196331 A1
(43) Pub. Date: Jun. 13, 2024

(54) APPROACHES FOR MULTI-LINK COMMUNICATION

(71) Applicant: Telefonaktiebolaget LM Ericsson (publ), Stockholm (SE)

(72) Inventors: Miguel LOPEZ, Aachen (DE); Abhishek AMBEDE, Huddinge (SE); Sebastian MAX, Cologne (DE); Leif WILHELMSSON, Lund (SE); Jonas SEDIN, Brentford Greater London (GB); Rocco DI TARANTO, Lund (SE)

(21) Appl. No.: 18/554,020

(22) PCT Filed: Apr. 7, 2021
(86) PCT No.: PCT/EP2021/059048

§ 371 Date: Oct. 5, 2023

(51) Int. Cl. H04W 52/02; H04W 48/18; H04W 76/15

(52) U.S. Cl. CPC H04W 52/0235; H04W 48/18; H04W 76/15

(57) ABSTRACT

A method for a radio access node configured for transmission to a user device over multiple links. The method includes, responsive to data being available for transmission to the user device, determining which of the multiple links are possible links for transmission of the data, selecting one or more links of the possible links, and transmitting a wake-up signal to the user device, wherein the wake-up signal is indicative of the selected one or more links. A method is also disclosed for a user device configured for reception from a radio access node over multiple links. The method includes receiving a wake-up signal from the radio access node, wherein the wake-up signal is indicative of one or more of the multiple links, and waking up one or more of the multiple receivers, corresponding to the indicated one or more links.

### TECHNICAL FIELD

The present disclosure relates generally to the field of wireless communication. More particularly, it relates to approaches for multi-link communication.

### BACKGROUND

There are various approaches for multi-link communication in wireless communication. Examples include multi-link operation (MLO; e.g., as defined in relation to IEEE 802.11 standards) and carrier aggregation (CA; e.g., as defined in relation to Third Generation Partnership Project, 3GPP, standards). Multi-link communication is also referred to herein as communication (i.e., transmission and/or reception) over multiple links.

Generally, multi-link communication may be defined as a situation where two or more links are available for communication of an information stream, where communication of the information stream may use one or more of the available links at each communication occasion, and where (all of) the available links are based on a same communication standard (e.g., an IEEE 802.11 standard or a 3GPP standard) and/or where (all of) the available links are based on a same version of a communication standard (e.g., IEEE 802.11 EHT). Typically, the different links of multi-link communication are distinguished by separation possibilities within the applied communication standard. For example, different links of multi-link communication may be distinguished by use of different channels, wherein different channels may be in the same frequency band or in different frequency bands.

A device (e.g., a radio access node or a user device) configured for multi-link communication typically has one instantiation per link of lower layer processing means (e.g., circuitry or software modules), while higher layer processing is performed collectively for all links.

Examples of lower layers include layers ranging from the physical layer to a medium access control (MAC) layer portion denoted as lower MAC. Examples of higher layers include layers ranging from a MAC layer portion denoted as upper MAC and upwards in a communication layer model. When used herein, the term “lower MAC” may refer to link specific MAC processing and the term upper MAC may refer to link independent MAC processing (and/or collective link MAC processing).

For example, in the context of an IEEE 802.11 standard, a legacy communication device typically has a single physical layer and one MAC layer, while a multi-link communication device has multiple station (STA) instantiations (each implementing physical layer functions and lower MAC functions) and a single instantiation for implementing upper MAC functions. Each of the multiple STA instantiations may be seen as representing a physical radio, and the upper MAC instantiation is configured to aggregate information of the multiple STA instantiations (i.e., information of the multiple STA instantiations is aggregated in the MAC layer). Thus, a multi-link device can be seen as a device with multiple STAs that operate semi-independently on different channels, but with a single interface towards the upper layers (e.g., layers above MAC).

Thus, a user device configured for reception over multiple links typically employ several receivers, which may result in relatively high power consumption.

Multi-link communication aims to increase performance (e.g., in terms of one or more of: throughput, latency, spectrum efficiency, etc.). However, there may be scenarios where multi-link communication is not immediately suitable or beneficial. Examples include scenarios where some power saving mode is required (or otherwise beneficial), and/or scenarios where performance requirements are low (e.g., in terms of throughput, latency, spectrum efficiency, etc.)—for example due to the traffic situation. Thus, the benefits of multi-link communications may be lost in such scenarios.

Therefore, there is a need for alternative approaches for multi-link communication. Preferably, such approaches reduce power consumption for multi-link communication devices.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

The term wake-up signal and its abbreviation WUS will be used interchangeably herein. Also, the term wake-up radio and its abbreviation WUR will be used interchangeably herein.

Generally, the time to channel access may be defined as “channel access time” (e.g., for IEEE 802.11 communication scenarios). It is an object of some embodiments to solve or mitigate, alleviate, or eliminate at least some of the above or other disadvantages.

A first aspect is a method for a radio access node configured for transmission to a user device over multiple links. The method comprises, responsive to data being available for transmission to the user device, determining which of the multiple links are possible links for transmission of the data. The method also comprises selecting one or more links of the possible links, and transmitting a wake-up signal to the user device, wherein the wake-up signal is indicative of the selected one or more links.

In some embodiments, the transmission over multiple links comprises multi-link operation and/or carrier aggregation.

In some embodiments, the method further comprises wake-up protocol execution for transmission of the data responsive to transmitting the wake-up signal.

In some embodiments, the method further comprises negotiating respective wake-up protocols for the multiple links with the user device.

In some embodiments, the wake-up signal is for indicating to the user device a request to wake up one or more receivers, corresponding to all of the selected one or more links or corresponding to a sub-set of the selected one or more links.

In some embodiments, the method further comprises allocating communication resources for the wake-up signal.

In some embodiments, the method further comprises transmitting an indication of the allocated wake-up signal communication resources to the user device.

In some embodiments, the wake-up signal is further indicative of which of the possible links are available for wake-up protocol signaling.

In some embodiments, selecting one or more links of the possible links is based on one or more of: link traffic load, link capacity, link budget, link channel bandwidth, link frequency band, link carrier frequency, link multiple-input multiple-output (MIMO) capability, link channel conditions, link interference, time to channel access for link, and amount of data to be transmitted.

A second aspect is a method for a user device configured for reception from a radio access node over multiple links. The user device comprises multiple receivers corresponding to the multiple links and one or more wake-up radios, wherein at least one of the one or more wake-up radios is configured to wake up two or more of the multiple receivers. The method comprises receiving a wake-up signal from the radio access node, wherein the wake-up signal is indicative of one or more of the multiple links, and waking up one or more of the multiple receivers, corresponding to the indicated one or more links.

In some embodiments, the reception over multiple links comprises multi-link operation and/or carrier aggregation.

In some embodiments, waking up one or more of the multiple receivers comprises waking up receivers corresponding to all of the indicated one or more links or corresponding to a sub-set of the indicated one or more links.

In some embodiments, the method further comprises selecting the sub-set based on one or more of: link traffic load, link capacity, link budget, link channel bandwidth, link frequency band, link carrier frequency, link MIMO capability, link channel conditions, link interference, and time to channel access for link.

In some embodiments, the method further comprises wake-up protocol execution for reception of data responsive to receiving the wake-up signal.

In some embodiments, the method further comprises negotiating respective wake-up protocols for the multiple links with the radio access node.

In some embodiments, the method further comprises configuring communication resources for each of the one or more wake-up radios for reception of the wake-up signal.

In some embodiments, the method further comprises receiving an indication of wake-up signal communication resources from the radio access node, wherein each of the indicated wake-up signal communication resources is configured for a respective one of the one or more wake-up radios for reception of the wake-up signal.

In some embodiments, the method further comprises transmitting an indication of the configuration to the radio access node.

In some embodiments, the wake-up signal is further indicative of which of the multiple links are available for wake-up protocol signaling.

A third aspect is a computer program product comprising a non-transitory computer readable medium, having thereon a computer program comprising program instructions. The computer program is loadable into a data processing unit and configured to cause execution of the method according to any of the first and second aspects when the computer program is run by the data processing unit.

A fourth aspect is an apparatus for a radio access node configured for transmission to a user device over multiple links. The apparatus comprises controlling circuitry configured to cause (responsive to data being available for transmission to the user device) determination of which of the multiple links are possible links for transmission of the data, selection of one or more links of the possible links, and transmission of a wake-up signal to the user device, wherein the wake-up signal is indicative of the selected one or more links.

A fifth aspect is a radio access node comprising the apparatus of the fourth aspect.

A sixth aspect is an apparatus for a user device configured for reception from a radio access node over multiple links. The user device comprises multiple receivers corresponding to the multiple links and one or more wake-up radios, wherein at least one of the one or more wake-up radios is configured to wake up two or more of the multiple receivers. The apparatus comprises controlling circuitry configured to cause reception of a wake-up signal from the radio access node, wherein the wake-up signal is indicative of one or more of the multiple links, and waking up of one or more of the multiple receivers, corresponding to the indicated one or more links.

A seventh aspect is a user device configured for reception from a radio access node over multiple links. The user device comprises the apparatus of the sixth aspect, multiple receivers corresponding to the multiple links, and one or more wake-up radios, wherein at least one of the one or more wake-up radios is configured to wake up two or more of the multiple receivers.

In some embodiments, any of the above aspects may additionally have features identical with or corresponding to any of the various features as explained above for any of the other aspects.

An advantage of some embodiments is that alternative approaches for multi-link communication are provided.

An advantage of some embodiments is that power saving for multi-link communication devices is achieved; possibly without substantial degradation in latency.

An advantage of some embodiments is that combination of multi-link communication and wake-up radio is enabled.

An advantage of some embodiments is that, since a single wake-up radio can be configured to wake up two or more links, an efficient wake-up radio implementation is provided (e.g., in terms of amount of WUR hardware) and/or overhead signaling (e.g., the amount of control frames) needed to wake up multiple links is reduced.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a combined flowchart and signaling diagram illustrating example method steps and signaling according to some embodiments;

FIG. 2 is a schematic block diagram illustrating an example apparatus according to some embodiments;

FIG. 3 is a schematic block diagram illustrating an example apparatus according to some embodiments;

FIG. 4A is a schematic block diagram illustrating an example transceiver according to some embodiments;

FIG. 4B is a schematic block diagram illustrating an example transceiver according to some embodiments; and

FIG. 5 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

It should be noted that, even though some exemplification herein relates to communication in relation to IEEE 802.11 standards, application of the principles described herein is not limited thereto. Contrarily, some embodiments may be equally applicable in relation to other wireless communication standards (e.g., 3GPP standards).

When a radio access node, or an access node, is referred to herein, it is intended as encompassing any suitable radio access node (e.g., an access point (AP), an access point station (AP-STA), a base station (BS), a NodeB, a gNB, etc.).

When a user device is referred to herein, it is intended as encompassing any suitable user device (e.g., a multi-link device (MLD), a station (STA), a non-AP-STA, a user equipment (UE), etc.).

In the following, embodiments will be described where wake-up radio (WUR) technology is used in the context of multi-link communication to enable reduced power consumption at the receiving device.

According to some embodiments, a selection of link(s) from a set of one or more possible links is made at the transmitting device, and the selection is indicated to the receiving device in a wake-up signal (WUS).

Proper selection of link(s) may provide for further advantages such as performance improvement.

According to some embodiments, an indication of selected link(s) is received by a WUR of the receiving device, and used by the WUR to determine which receiver(s) to wake up.

Generally, it should be understood that when the term receiver is used herein, it is meant to refer to a non-WUR receiver (e.g., a main receiver, configured for reception of signals other than WUSs).

As already mentioned, multi-link communication may be defined as a situation where two or more links are available for communication of an information stream, where communication of the information stream may use one or more of the available links at each communication occasion, and where (all of) the available links are based on a same communication standard.

Thus, using WUR technology in the context of multi-link communication typically requires different considerations than when a single WUR is used in the context of two or more receivers applying different communication standards. An example of the latter is described in WO2018/108264A1.

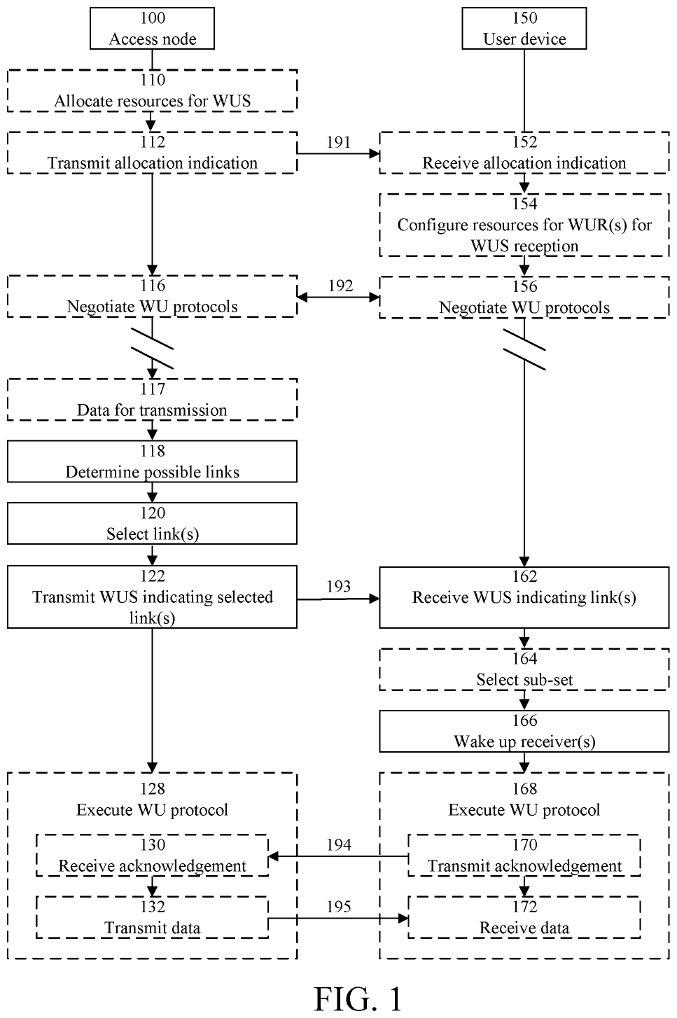

FIG. 1 is a combined flowchart and signaling diagram illustrating example method steps for (e.g., performed in) a (radio) access node 100, example method steps for (e.g., performed in) a user device 150, and corresponding signaling between the access node 100 and the user device 150.

The access node 100 is configured for transmission to the user device 150 over multiple links, and the user device 150 is configured for reception from the access node 100 over multiple links. As already mentioned, communication (e.g., transmission and/or reception) over multiple links may comprise multi-link operation (MLO; e.g., as defined in relation to IEEE 802.11 standards) and/or carrier aggregation (CA; e.g., as defined in relation to 3GPP standards), for example.

The user device comprises multiple receivers corresponding to the multiple links and one or more wake-up radios (WURs), wherein at least one of the one or more wake-up radios is configured to wake up two or more of the multiple receivers.

For example, the user device may comprise a single WUR configured to wake up any one(s) of the multiple receivers.

Alternatively, the multiple receivers may be divided into two or more groups where each group has an associated WUR configured to wake up any receiver(s) of the group. Typically, each receiver is comprised in exactly one group, and at least one group comprises more than one receiver.

Responsive to there being data (e.g., a data frame) available for transmission to the user device 150, the access node determines which of the multiple links are possible links for transmission of the data, as illustrated by step 118.

The determination of possible links in step 118 may comprise starting from the set of multiple links and discarding links which are not allowable and/or not feasible for transmission of the data.

For example, the determination of possible links in step 118 may be based on knowledge from earlier negotiation regarding link establishment.

Alternatively or additionally, the determination of possible links in step 118 may be based on channel information from a network controller. For example, in a scenario where the network controller applies frequency planning (e.g., to create a completely controlled environment), two MLD APs may be assigned two disjoint sets of channels to serve their respective STAs.

Yet alternatively or additionally, the determination of possible links in step 118 may be based on a traffic identifier (TID) of the data. In IEEE 802.11 standards, data frames are assigned a TID for purposes of quality of service (Qos). The TID specifies which traffic stream a frame belongs to, and may be signaled as part of the MAC header. For example, in IEEE 802.11be a TID-to-link mapping is defined whereby a TID is tied to certain link(s) where frames of the traffic stream are allowed to be transmitted. Hence, the possible links may be implicitly known from the TID.

In some situations applying MLO, a TID may be mapped to a single link, or to a set of links, which means that the TID of a data frame may specify which link(s) it may be transmitted over; i.e., the possible link(s).

Alternatively, in some situations applying MLO, there may be no mapping from TID to link(s), which means that there is no limitation posed by the TID of a data frame regarding which link(s) may be used for transmission. For example, all of the multiple links may be determined as possible links in such situations.

The method may also comprise determining that there is data available for transmission to the user device, as illustrated by optional step 117. For example, step 117 may comprise one or more of: low layer processing means receiving data (e.g., a data frame) from high level processing means, detecting that there is data in a transmission buffer, etc.

In step 120, the access node 100 selects one or more (e.g., one, two, or more) links of the possible links. The selected link(s) may be seen as a set of links for transmission.

The selection in step 120 of one or more links of the possible links may be performed in any suitable way. For example, the selection in step 120 may be based on one or more of: link traffic load, link capacity, link budget, link channel bandwidth, link frequency band, link carrier frequency, link MIMO capability, link channel conditions, link interference, time to channel access for link, and amount of data to be transmitted (e.g., size of the payload).

Typically, the selection in step 120 may aim to improve performance (e.g., of the transmission of the data and/or of the overall system).

In some examples, link(s) with lowest traffic load among the possible links (or with traffic load below a traffic load threshold value) may be selected. This approach may result in relatively low latency for the data transmission.

In some examples, link(s) with lowest interference among the possible links (or with interference below a traffic load threshold value) may be selected. This approach may result in relatively low latency for the data transmission.

In some examples, link(s) among the possible links with capacity that accommodates (e.g., matches) the amount of data to be transmitted may be selected. This approach may result in relatively high utilization of the system resources.

In some examples, link(s) among the possible links with channel bandwidth that accommodates (e.g., matches) the amount of data to be transmitted may be selected. This approach may result in relatively high utilization of the system resources.

In some examples, link(s) with highest channel bandwidth among the possible links (or with channel bandwidth above a channel bandwidth threshold value) may be selected. This approach may result in relatively low over-the-air time occupancy in relation to amount of data to be transmitted.

In some examples, link(s) with a suitable carrier frequency may be selected. This approach provides a possibility to trade off coverage against throughput (relatively low carrier frequency entails relatively large coverage—large distance—while relatively high carrier frequency entails relatively high throughput.

In some examples, link(s) among the possible links with MIMO capabilities that accommodates (e.g., matches) the amount of data to be transmitted may be selected. This approach may result in relatively high utilization of the system resources.

Combinations of the above examples are also possible. For example, link(s) among the possible links with capacity that accommodates the amount of data to be transmitted may be determined as candidate link(s) and link(s) with lowest traffic load among the candidate link(s) may be selected.

In step 122, the access node 100 transmits a wake-up signal (WUS) 193 to the user device 150, and the user device 150 receives the WUS 193 in step 162. Generally, the WUS 193 is (explicitly or implicitly) indicative of that there is data for transmission to the user device 150. The WUS 193 is also indicative of the selected one or more links. The WUS 193 is for indicating to the user device 150 a request to wake up one or more receivers.

In step 166, the user device wakes up one or more of the multiple receivers, corresponding to the indicated one or more links of the WUS.

In some embodiments, the WUS indicates specifically which link(s) that are to be used for transmission of the data. Thus, the WUS is for indicating to the user device 150 a request to wake up receivers corresponding to all of the selected one or more links. Then, step 166 may comprise waking up receivers corresponding to all of the indicated one or more links.

In some embodiments, the WUS indicates preferable link(s) for transmission of the data, wherein the number of preferable link(s) indicated is higher than the number of link(s) required for the transmission of the data. Thus, the WUS is for indicating to the user device 150 a request to wake up receivers corresponding to a sub-set of the selected one or more links, e.g., wherein the sub-set is selectable by the user device 150. Then, step 166 may comprise waking up receivers corresponding to a sub-set of the indicated one or more links.

In some embodiments, the WUS indicates one or more of: how many links the sub-set should comprise, a minimum number of links the sub-set should comprise, and a maximum number of links the sub-set should comprise.

As illustrated by optional step 164, the user device 150 may, when the WUS indicates preferable link(s), select the sub-set (e.g., how many and/or which links the sub-set comprises).

The selection may be based on one or more of: link traffic load, link capacity, link budget, link channel bandwidth, link frequency band, link carrier frequency, link MIMO capability, link channel conditions, link interference, and time to channel access for link. For example, step 164 may comprise similar considerations as step 120. Where the selection is performed (in step 120 by the access node 100, in step 164 by the user device 150, or partly in step 120 and partly in step 164) may depend on whether the access node 100 or the user device 150 has better knowledge regarding the parameters used for selection.

Typically, the user device 150 also indicates the link(s) for which receiver(s) have been woken up to the access node 100 in these embodiments. Such indication may be explicit or implicit (e.g., by wake-up protocol signaling from the woken-up receiver(s)).

After WUS has been transmitted in step 122 and received in step 162, and the receiver(s) have been woken up in step 166, the access node 100 and the user device 150 may execute a wake-up protocol for transmission and reception of the data, as illustrated by optional steps 128 and 168, respectively.

The wake-up protocol may be any suitable protocol. For example, it may be any WUR protocol as specified by the WUR standard in relation to IEEE 802.11 communication. The WUR protocol may comprise a negotiation phase where a power save (PS) protocol is agreed upon (e.g., a PS protocol as specified by the IEEE 802.11 standards, such as IEEE 802.11ax draft 8.0; examples include “Power Management” and “Target Wake Time (TWT)”).

As illustrated by optional sub-steps 132, 172, the wake-up protocol execution may comprise the access node 100 transmitting the data 195 to the user device 150.

In some embodiment, the wake-up protocol execution may also comprise the user device 150 transmitting (e.g., by the woken-up receiver(s)) an acknowledgement 194 (e.g., a poll packet) to the access node 100 to trigger the data transmission, as illustrated by optional sub-steps 170, 130.

In some embodiment, the wake-up protocol execution may also comprise the access node 100 transmitting a trigger signal (e.g., a trigger frame) to the user device 150 to trigger the acknowledgement transmission and/or to announce the data transmission.

In some embodiments, the WUS is further indicative of which of the possible links are available for wake-up protocol signaling (e.g., which link(s) can/should be used for trigger signal, and/or which link(s) can/should be used for acknowledgement). For example, acknowledgement and data might need to be transmitted on the same link, or it may be allowed/stipulated to transmit acknowledgement and data on different links.

Some embodiments provide varying degrees of flexibility regarding which links may be used for WUS signaling and/or which links (of the selected links) may be used for wake-up protocol signaling (e.g., trigger signal, acknowledgement, and data).

In one example, the same link is used for transmission of WUS and all wake-up protocol signaling (which may be one way of indicating link selection in the WUS). In one example, the same link is used for all wake-up protocol signaling (which may be one way of indicating in the acknowledgement which link to use for data), while the WUS may, or may not, be transmitted on another link. In one example, different links may be used for different wake-up protocol signaling and/or for the WUS.

For some, or all, of the wake-up protocol signaling, the transmitting device (radio access node or user device) may need to perform a listen-before talk (LBT) procedure or other clear channel assessment (CCA) to gain channel access before it can transmit the protocol signal. In such situations, it may be beneficial to have full flexibility regarding which links may be used for wake-up protocol signaling, such that the transmitting device may use the link on which channel access is gained first.

In some embodiments, the methods of FIG. 1 may further comprise that the access node 100 and the user device 150 negotiate respective wake-up protocols for (all of) the multiple links, as illustrated by optional steps 116 and 156. The wake-up protocols for the multiple links may be the same wake-up protocol for all (or some) of the links, and/or may differ between all (or some) of the links.

The wake-up protocol negotiation may comprise any suitable protocol and signaling 192. For example, steps 116 and 156 may comprise executing handshaking operations for the respective wake-up protocols (e.g., as defined for the WUR standard in relation to IEEE 802.11 communication).

Steps 116 and 156 are typically executed less often than the earlier described method steps caused by data being available for transmission. For example, the negotiation of steps 116 and 156 may be performed periodically and/or based on a triggering event (e.g., poor wake-up performance).

Further, each execution of steps 116 and 156 may relate to all of the multiple links, some of the multiple links, or one of the multiple links.

Various embodiments are envisioned for transmission and reception of the wake-up signal (WUS). Generally, the WUS is communicated using communication resources, which will be referred to as wake-up signal communication resources. The wake-up signal communication resources may be defined using parameters (e.g., frequency band, carrier frequency, bandwidth, etc.) corresponding to one or more of the multiple links, or different parameters. Thus, the communication resources for the wake-up signal may belong to one or more of the multiple links and/or to one or more of the possible links.

In some embodiments, communication resources for transmission and reception of the wake-up signal is predetermined.

In some embodiments, communication resources for transmission and reception of the wake-up signal may be (dynamically) allocated.

Such allocation is typically executed less often than the earlier described method steps caused by data being available for transmission. For example, the allocation may be performed periodically and/or based on a triggering event (e.g., poor wake-up performance).

The allocation of wake-up signal communication resources may be performed by the access node 100 according to some embodiments, as illustrated by optional step 110. Then, the access node 100 may transmit an indication 191 of the allocated wake-up signal communication resources to the user device 150, as illustrated by optional steps 112 and 152. The user device 150 may configure each of the indicated wake-up signal communication resources for a respective wake-up radio for reception of the wake-up signal, as illustrated by optional step 154.

The allocation of wake-up signal communication resources may be performed by the user device 150 according to some embodiments. Then, the user device 150 may configure communication resources for each wake-up radio for reception of the wake-up signal. The user device 150 may transmit an indication of the configured wake-up signal communication resources to the access node 100, so that the access node 100 knows where the WUS should be transmitted.

The allocation of wake-up signal communication resources may be performed in any suitable way. For example, when the wake-up signal communication resources are to be selected from the multiple links, the allocation may be based on one or more of: link traffic load, link capacity, link budget, link bandwidth, link frequency band, link channel conditions, link interference, and time to channel access for link. For example, the allocation of wake-up signal communication resources may aim to achieve a desired WUS reception performance and/or to keep disturbance caused by the WUS at an acceptable level.

Thus, according to embodiments presented herein, alternative approaches for multi-link communication are provided. The use of WUR(s) in the multi-link communication user device provides for power saving since the other receivers can be operated in a low power mode (e.g., sleep mode) when there is no data to receive. Using less WUR(s) than other receivers (e.g., a single WUR) provides for efficient implementation (e.g., in terms of WUR hardware). The flexible selection (in the radio access node and/or in the user device) of which link(s) to use for data communication and/or wake-up protocol signaling enables improved performance of multi-link communication (e.g., in terms of one or more of: throughput, latency, spectrum efficiency, etc.).

Some further exemplification related to some embodiments will now be presented in relation to IEEE 802.11 communication. In IEEE 802.11 communication, stations (STAs) are classified as access point stations (AP STAs; an exemplification of a radio access node) or non-access point stations (non-AP STAs; an exemplification of a user device). For ease of notation, the description herein will follow common terminology and let AP refer to AP STA and STA refer to non-AP STA.

The IEEE 802.11 standard evolves continuously to support new use cases and to enhance existing functionality. Some embodiments may be seen as related to two amendments of IEEE 802.11 standards, namely IEEE 802.11ba and IEEE 802.11be.

The IEEE 802.11ba task group (TGba) relates to a standard amendment to support wake-up radio (WUR) technology to enable STAs to benefit from the power savings enabled by sleep mode without sacrificing reachability. WURs enable significant reductions of power consumption for receivers used in wireless communication. Generally, a WUR only needs to be able to detect presence of a wake-up signal (WUS) and is not used for any data reception. Therefore, a WUR can be based on a very simple architecture.

The TGba relates to standardization of the physical layer (PHY) and the medium access control (MAC) for a WUR to be used as a companion radio to the main IEEE 802.11 radio (i.e., the radio configured for IEEE 802.11 communication). In IEEE 802.11ba, a WUR AP is an AP that supports the WUR operation; e.g., that is capable of transmitting WUR PHY protocol data units (WUR PPDUs; an exemplification of a WUS) and executing corresponding wake-up protocol(s). Similarly, a WUR STA (also referred to herein as a WUR) is a STA that supports the WUR operation; e.g., that is capable of receiving WUR PPDUs and executing corresponding wake-up protocol(s).

Typically, a WUR AP is configured to transmit a WUR wake-up frame (e.g., in the form of a WUR PPDU) to a WUR STA to indicate availability of bufferable units (BUs) which are addressed to the STA, and both the AP and the STA are configured to follow a previously agreed wake-up protocol.

The IEEE 802.11be task group (TGbe) relates to a standard amendment termed Extremely High Throughput (EHT), aiming to support, e.g., increased data rate and decreased latency. One feature introduced in EHT is multi-link operation (MLO); supported by multi-link devices. A multi-link device (MLD) is a logical and/or physical entity that has more than one affiliated station (STA; also referred to herein as multiple communication receivers, or simply multiple receivers) and has a single medium access control (MAC) service access point (SAP) for the upper layers of the communications stack (upper MAC). Thus, an MLD has several radio chains and is capable of simultaneous communication on two or more radio frequency (RF) links.

In IEEE 802.11 communication, frames are assigned a so-called traffic identifier (TID) for quality of service (QOS) purposes. In MLO, a TID may be mapped to a link or to a set of links, wherein the mapping denotes which links can be used for communication of frames having a particular TID. If there is no mapping between TID and link(s), a frame having that TID may be communicated over any link.

Multi-link operation is beneficial to increase throughput and reduce latency. However, it typically increases power consumption. Therefore, power saving mechanisms may be needed, and some embodiments suggest application of WUR technology in the context of MLO. One solution might be to have a separate WUR for each STA of an MLD.

However, letting the MLD have fewer WURs than STAs (e.g., a single WUR) might be more efficient. This may be achieved by at least one of the WURs being configured to wake up two or more of the STAs. For example, a single WUR may be configured to wake up all of the STAs. Alternatively or additionally, each WUR in a collection of WURs may be configured to wake up respective one or more STAs such that each STA can be woken up by at least one WUR.

According to some embodiments, an AP MLD is configured to—when it receives a frame intended for a non-AP MLD having an affiliated WUR STA (compare with step 117 of FIG. 1)—determine the links over which it can be transmitted (the possible links; compare with step 118 of FIG. 1), and select—from the possible links—a set of one or more links for transmission (compare with step 120 of FIG. 1). The AP MLD may also be configured to—if any of the non-WUR STAs affiliated with the non-AP MLD and servicing a selected link is in doze state—send a WUR frame to the WUR STA informing the non-AP MLD of the availability of BUs and indicating the set of selected links (compare with step 122 of FIG. 1).

Various advantages may be achieved by application of embodiments described herein. Some examples include increased spectrum efficiency, decreased power consumption, and decreased latency.

For example, the possible links may have different capacities (e.g., due to channel bandwidth, multiple-input multiple-output (MIMO) capability of the STA, etc.) and/or different traffic loads. When the AP MLD has such information, it may select the links for transmission based thereon (e.g., to balance the network load, reduce the collision probability, reduce the latency, etc.).

Thus, some embodiments suggest modes of operation for non-AP MLDs having an affiliated WUR STA, wherein all STAs affiliated with the non-AP MLD may switch to a low power state (e.g., a doze state or a sleep state). A PS operating mode may be agreed for each link (i.e., for each affiliated STA), e.g., using a suitable known approach. When an AP MLD receives a frame for transmission to the non-AP MLD, it determines the links on which transmission is allowed (the possible links), based on the TID. Then, it selects a set of links for transmission, from the links on which transmission is allowed, and transmits a wake-up frame to the WUR STA, indicating that there are BUs addressed to the non-AP MLD and the set of selected links. Upon detection of the wake-up frame, the non-AP MLD may initiate the PS operation on each of the indicated links. Typically, this entails switching the corresponding affiliated STAs to an active mode, synchronizing the STAs to the wireless medium on the indicated links, sending acknowledgements to the corresponding AP, and receiving data transmissions from the AP.

As already mentioned, the link selection may be based on, for example, one or more of the link traffic load, the link capacity, and the link budget.

In one example, a non-AP MLD may be considered that has three affiliated STAs supporting three links, wherein it has been agreed in negotiation to use the target wake time (TWT) PS operation on each link. When a data frame arrives at the AP MLD it may be determined (based on mapping of TID to link) to be possible to transmit the data frame over two of the three links. If a first link of these two links operates on a channel with a heavy traffic load, while a second (the other) link of these two links operates on a channel with a light traffic load, then the AP MLD may select the second link for transmission, and indicate the second link in the WUR frame. The STA affiliated to the non-AP MLD and corresponding to the second link may be switched from a doze state to an active state at a target wake time as agreed in negotiation with its AP, and may start scanning the wireless medium on the RF channel corresponding to the second link. The AP may transmit a trigger frame after the time agreed in negotiation, and the STA may reply with a PS-Poll. Then, the AP knows that the STA is ready to receive the data on the second link and may proceed to transmit the data frame.

In one example, an AP MLD may be considered, which—in the WUR frame—indicates to the non-AP MLD that the non-AP MLD can select to wake up only one, or few, of the STAs corresponding to the indicated links selected by the AP MLD. The non-AP MLD may then select a sub-set of STAs to wake up (compare with step 164 of FIG. 1). The non-AP MLD may select the sub-set based on, for example, one or more of link capacity, the link channel quality, and link interference level. The AP MLD may be implicitly or explicitly notified of the sub-set (e.g., via acknowledgement frames sent by the STAs that are woken up), and the AP MLD may perform transmissions to these STAs. This example illustrates a flexibility for the non-AP MLD which can be attractive for non-AP MLDs with restricted multi-link capabilities (e.g., enhanced multi-link single radio (EMLSR), wherein unrestricted reception can only be performed on one link at a time while restricted functions, such as clear channel assessment (CCA), can be performed on other links).

In one example, an AP MLD can announce that it supports WUR only on specific link(s) (e.g., by signaling WUR operating parameters on an MLD level instead of on STA level, and indicating the specific link(s)). This allows the AP MLD to control on which link(s) the WUR STAs should operate, and enables grouping of all non-AP WURs on specific link(s). An advantage with this approach is reduced WUS signaling.

Generally, when MLO is used together with a single WUR, a determination may be made (by radio access node or user device) regarding on which link the WUR should be placed. For example, the determination may be based on link budget (e.g., placing the WUR on the link with lowest carrier frequency). Alternatively or additionally, the determination may be based on how much resources would be used for WUS (e.g., placing the WUR on the link with smallest bandwidth). Yet alternatively or additionally, the determination may be based on expected time to channel access (e.g., placing the WUR on the link with lowest interference and/or lowest traffic load).

Typically, the wake-up signal may be sent on a first link and a second link (e.g., the link of the woken up receiver) is used for acknowledgement (e.g., in form of a poll packet) and data communication. The first and second links may be the same link or different links. The user device may have to perform CCA before sending the acknowledgement and the radio access node may also have to perform CCA before sending the data.

In some embodiments, the acknowledgement and the data communication may be allowed to use different links. Thus, the wake-up signal, the acknowledgement, and the data may all be sent on different links. This may be beneficial, for example, if low latency is important.

For example, the WUS can indicate that it is allowed to send the acknowledgment on any of two or more of the links. Thereby, the user device can perform CCA in parallel on these links and send the acknowledgement on the link that first is found to be idle. Alternatively or additionally, when the radio access node has received the acknowledgement, it may perform CCA in parallel on two or more of the selected links and send the data on the link that first is found to be idle. Yet alternatively or additionally, if the non-AP MLD has more than one WUR, the WURs may be allocated to different links, and the radio access node may perform CCA in parallel on these links and send the WUS on the link that first is found to be idle.

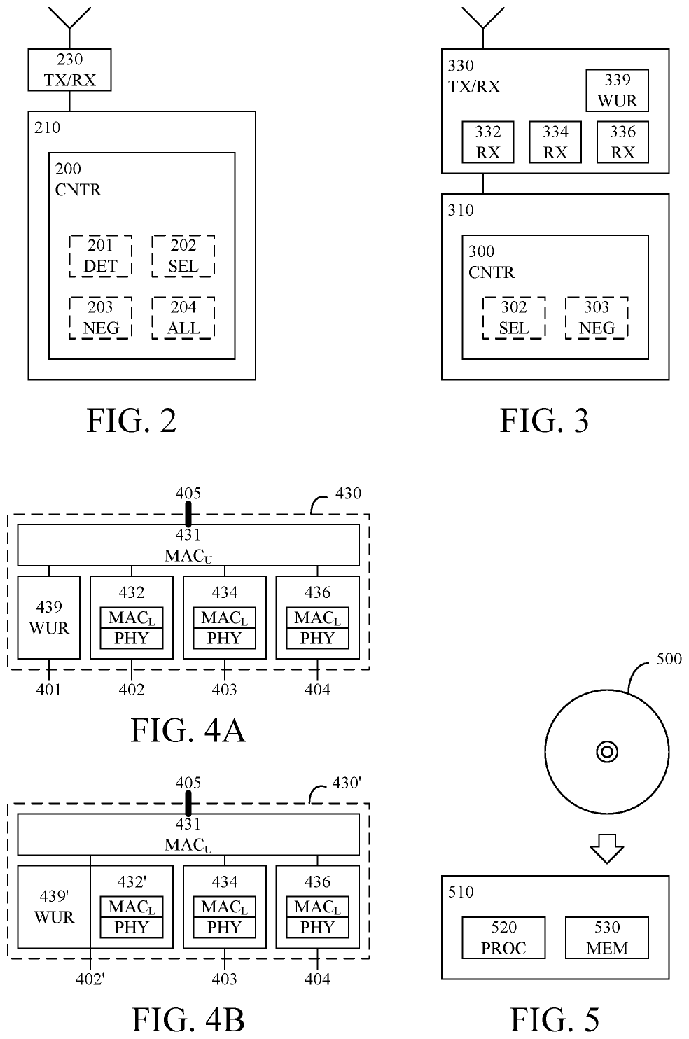

FIG. 2 schematically illustrates an example apparatus 210 according to some embodiments. The apparatus 210 is for a radio access node configured for transmission to a user device over multiple links.

For example, the apparatus 210 may be comprisable (e.g., comprised) in a radio access node. Alternatively or additionally, the apparatus 210 may be configured to cause execution of (e.g., configured to perform) one or more of the method steps of the access node 100 described in connection to FIG. 1.

The apparatus 210 comprises a controller (CNTR; e.g., controlling circuitry or a control module) 200.

The controller 200 is configured to cause, responsive to data being available for transmission to the user device, determination of which of the multiple links are possible links for transmission of the data (compare with step 118 of FIG. 1).

To this end, the controller 200 may comprise, or be otherwise associated with (e.g., connectable, or connected, to) a determiner (DET; e.g., determining circuitry or a determination module) 201. The determiner 201 may be configured to determine which of the multiple links are possible links for transmission of the data.

The controller 200 is also configured to cause selection of one or more links of the possible links (compare with step 120 of FIG. 1).

To this end, the controller 200 may comprise, or be otherwise associated with (e.g., connectable, or connected, to) a selector (SEL; e.g., selecting circuitry or a selection module) 202. The selector 202 may be configured to select one or more links of the possible links.

The controller 200 is also configured to cause transmission of a wake-up signal to the user device, wherein the wake-up signal is indicative of the selected one or more links (compare with step 122 of FIG. 1).

To this end, the controller 200 may comprise, or be otherwise associated with (e.g., connectable, or connected, to) a transmitter (TX; e.g., transmitting circuitry or a transmission module); illustrated in FIG. 2 as part of a transceiver (TX/RX) 230. The transmitter may be configured to transmit the wake-up signal to the user device, wherein the wake-up signal is indicative of the selected one or more links.

The controller 200 may also be configured to cause wake-up protocol execution for transmission of the data responsive to transmission of the wake-up signal (compare with step 128 of FIG. 1).

To this end, the controller 200 may comprise, or be otherwise associated with (e.g., connectable, or connected, to) a transmitter (TX; e.g., transmitting circuitry or a transmission module) and a receiver (RX; e.g., receiving circuitry or a reception module); both illustrated in FIG. 2 as part of the transceiver (TX/RX) 230. The transmitter and receiver may be configured to execute the wake-up protocol.

The controller 200 may also be configured to cause negotiation of respective wake-up protocols for the multiple links with the user device (compare with step 116 of FIG. 1).

To this end, the controller 200 may comprise, or be otherwise associated with (e.g., connectable, or connected, to) a wake-up protocol negotiator (NEG; e.g., negotiating circuitry or a negotiation module) 203. The wake-up protocol negotiator 203 may be configured to negotiate the respective wake-up protocols (e.g., by signaling via the transceiver 230).

The controller 200 may also be configured to cause allocation of communication resources for the wake-up signal and transmission of an indication of the allocated wake-up signal resources to the user device (compare with steps 110, 112 of FIG. 1).

To this end, the controller 200 may comprise, or be otherwise associated with (e.g., connectable, or connected, to) an allocator (ALL; e.g., allocating circuitry or an allocation module) 204 and transmitter (TX; e.g., transmitting circuitry or a transmission module); illustrated in FIG. 2 as part of the transceiver (TX/RX) 230. The allocator 204 may be configured to allocate the communication resources for the wake-up signal and the transmitter may be configured to transmit the indication of the allocated wake-up signal resources to the user device.

FIG. 3 schematically illustrates an example apparatus 310 according to some embodiments. The apparatus 310 is for a user device configured for reception from a radio access node over multiple links.

For example, the apparatus 310 may be comprisable (e.g., comprised) in a user device. Alternatively or additionally, the apparatus 310 may be configured to cause execution of (e.g., configured to perform) one or more of the method steps of the user device 150 described in connection to FIG. 1.

The user device comprises multiple receivers (RX) 332, 334, 336 corresponding to the multiple links. The user device also comprises one or more wake-up radios (WUR) 339, wherein at least one WUR is configured to wake up two or more of the multiple receivers. For example, the user device may comprise a single WUR 339 configured to wake up any one(s) of the multiple receivers 332, 334, 336.

The apparatus 310 comprises a controller (CNTR; e.g., controlling circuitry or a control module) 300.

The controller 300 is configured to cause reception of a wake-up signal from the radio access node, wherein the wake-up signal is indicative of one or more of the multiple links (compare with step 162 of FIG. 1), and waking up of one or more of the multiple receivers, corresponding to the indicated one or more links (compare with step 166 of FIG. 1).

To this end, the controller 300 may comprise, or be otherwise associated with (e.g., connectable, or connected, to) a wake-up receiver (i.e., a wake-up radio, WUR; e.g., wake-up receiving circuitry or a wake-up reception module) 339; illustrated in FIG. 3 as part of a transceiver (TX/RX) 330. The wake-up receiver 339 may be configured to receive the wake-up signal and wake up of one or more of the multiple receivers 332, 334, 336.

The controller 300 may be configured to cause waking up of receivers corresponding to all of the indicated one or more links or corresponding to a sub-set of the indicated one or more links. In the latter case, the controller 300 may be further configured to cause selection of the sub-set (compare with step 164 of FIG. 1).

To this end, the controller 300 may comprise, or be otherwise associated with (e.g., connectable, or connected, to) a selector (SEL; e.g., selecting circuitry or a selection module) 302. The selector 302 may be configured to select the sub-set.

The controller 300 may also be configured to cause wake-up protocol execution for reception of data responsive to reception of the wake-up signal (compare with step 168 of FIG. 1).

To this end, the controller 300 may comprise, or be otherwise associated with (e.g., connectable, or connected, to) a transmitter (TX; e.g., transmitting circuitry or a transmission module) and a receiver (RX; e.g., receiving circuitry or a reception module); both illustrated in FIG. 3 as part of the transceiver (TX/RX) 330. The transmitter and receiver may be configured to execute the wake-up protocol.

The controller 300 may also be configured to cause negotiation of respective wake-up protocols for the multiple links with the radio access node (compare with step 156 of FIG. 1).

To this end, the controller 300 may comprise, or be otherwise associated with (e.g., connectable, or connected, to) a wake-up protocol negotiator (NEG; e.g., negotiating circuitry or a negotiation module) 303. The wake-up protocol negotiator 303 may be configured to negotiate the respective wake-up protocols (e.g., by signaling via the transceiver 330).

It should be noted that method steps otherwise described herein may be equally applicable (mutatis mutandis) in relation to the apparatus 210 and/or the apparatus 310, even if not explicitly described in connection thereto.

FIG. 4A schematically illustrates an example transceiver 430 according to some embodiments. For example, the transceiver 430 may be seen as an example of the transceiver 330 of FIG. 3.

The transceiver 430 is for a user device configured for reception from a radio access node over multiple links 402, 403, 404. For example, the transceiver 430 may be comprisable (e.g., comprised) in a user device.

The reception over multiple links may comprise that the two or more links are available for reception of an information stream 405, where reception of the information stream 405 may be over one or more of the available links 402, 403, 404 at each reception occasion.

The transceiver 430 comprises multiple receivers 432, 434, 436 corresponding to the multiple links 402, 403, 404 and a wake-up radio (WUR) 439 associated with a separate reception link 401.

The multiple receivers 432, 434, 436 may be seen as providing one instantiation of lower layer processing (physical layer, PHY, and lower mac, MACL) per link 402, 404, 406, while higher layer processing (upper MAC, MACu) is performed collectively for all links as illustrated by 431. The WUR 439 is configured to wake up any one(s) of the multiple receivers 432, 434, 436.

The WUR 439 may be a WUR STA and each of the multiple receivers 432, 434, 436 may be a non-WUR STA, for example.

FIG. 4B schematically illustrates an example transceiver 430′ according to some embodiments. For example, the transceiver 430′ may be seen as an example of the transceiver 330 of FIG. 3.

The transceiver 430′ is for a user device configured for reception from a radio access node over multiple links 402′, 403, 404. For example, the transceiver 430′ may be comprisable (e.g., comprised) in a user device.

The reception over multiple links may comprise that the two or more links are available for reception of an information stream 405, where reception of the information stream 405 may be over one or more of the available links 402′, 403, 404 at each reception occasion.

The transceiver 430′ comprises multiple receivers 432′, 434, 436 corresponding to the multiple links 402′, 403, 404 and a wake-up radio (WUR) 439′ associated with the link 402′ and implemented in association with the receiver 432′.

The multiple receivers 432′, 434, 436 may be seen as providing one instantiation of lower layer processing (physical layer, PHY, and lower mac, MACL) per link 402′, 404, 406, while higher layer processing (upper MAC, MACu) is performed collectively for all links as illustrated by 431. The WUR 439′ is configured to wake up any one(s) of the multiple receivers 432′, 434, 436.

The WUR 439′ may be a WUR STA and each of the multiple receivers 432′, 434, 436 may be a non-WUR STA, for example.

Having the WUR deployed in isolation as illustrated in FIG. 4A may provide higher flexibility than having the WUR deployed together with a communication receiver as illustrated in FIG. 4B. For example, having the WUR deployed in isolation enables the WUR (e.g., all WURs of all relevant MLDs) to be operable on a first frequency band (e.g., the relatively bandwidth-constrained 2.4 GHz band), while communication receivers may be operable on one or more second frequency bands (e.g., the 5 and/or 6 GHz bands).

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a radio access node or a user device.

Embodiments may appear within an electronic apparatus (such as a radio access node or a user device) comprising arrangements, circuitry, and/or logic according to any of the embodiments described herein. Alternatively or additionally, an electronic apparatus (such as a radio access node or a user device) may be configured to perform methods according to any of the embodiments described herein.

According to some embodiments, a computer program product comprises a tangible, or non-tangible, computer readable medium such as, for example a universal serial bus (USB) memory, a plug-in card, an embedded drive or a read only memory (ROM). FIG. 5 illustrates an example computer readable medium in the form of a compact disc (CD) ROM 500. The computer readable medium has stored thereon a computer program comprising program instructions. The computer program is loadable into a data processor (PROC; e.g., data processing circuitry or a data processing unit) 520, which may, for example, be comprised in a radio access node or a user device 510. When loaded into the data processor, the computer program may be stored in a memory (MEM) 530 associated with or comprised in the data processor. According to some embodiments, the computer program may, when loaded into and run by the data processor, cause execution of method steps according to, for example, any of the methods illustrated in FIG. 1, or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1. A method for a radio access node configured for transmission to a user device over multiple links, the method comprising:
responsive to data being available for transmission to the user device, determining which of the multiple links are possible links for transmission of the data;
selecting one or more links of the possible links; and
transmitting a wake-up signal to the user device, the wake-up signal being indicative of the selected one or more links.

2. The method of claim 1, wherein the transmission over multiple links comprises one or both of multi-link operation and carrier aggregation.

3. The method of claim 1, further comprising wake-up protocol execution for transmission of the data responsive to transmitting the wake-up signal.

4. The method of claim 1, further comprising negotiating respective wake-up protocols for the multiple links with the user device.

5. The method of claim 1, wherein the wake-up signal is for indicating to the user device a request to wake up one or more receivers, corresponding to all of the selected one or more links or corresponding to a sub-set of the selected one or more links.

6. The method of claim 1, further comprising allocating communication resources for the wake-up signal; and
transmitting an indication of the allocated wake-up signal communication resources to the user device.

7. (canceled)

8. The method of claim 1, wherein the wake-up signal is further indicative of which of the possible links are available for wake-up protocol signaling.

9. The method of claim 1, wherein selecting one or more links of the possible links is based on one or more of:
link traffic load, link capacity, link budget, link channel bandwidth, link frequency band, link carrier frequency, link multiple-input multiple-output (MIMO) capability, link channel conditions, link interference, time to channel access for link, and amount of data to be transmitted.

10. A method for a user device configured for reception from a radio access node over multiple links, wherein the user device comprises multiple receivers corresponding to the multiple links and one or more wake-up radios, at least one of the one or more wake-up radios being configured to wake up two or more of the multiple receivers, the method comprising:
receiving a wake-up signal from the radio access node, the wake-up signal being indicative of one or more of the multiple links; and
waking up one or more of the multiple receivers corresponding to the indicated one or more links.

11. The method of claim 10, wherein the reception over multiple links comprises multi-link operation and/or carrier aggregation.

12. The method of claim 10, wherein waking up one or more of the multiple receivers comprises waking up receivers corresponding to all of the indicated one or more links or corresponding to a sub-set of the indicated one or more links.

13. The method of claim 12, further comprising selecting the sub-set based on one or more of:
link traffic load, link capacity, link budget, link channel bandwidth, link frequency band, link carrier frequency, link multiple-input multiple-output (MIMO) capability, link channel conditions, link interference, and time to channel access for link.

14. The method of claim 10, further comprising wake-up protocol execution for reception of data responsive to receiving the wake-up signal.

15. The method of claim 10, further comprising negotiating respective wake-up protocols for the multiple links with the radio access node.

16. The method of claim 10, further comprising configuring communication resources for each of the one or more wake-up radios for reception of the wake-up signal;
receiving an indication of wake-up signal communication resources from the radio access node, wherein each of the indicated wake-up signal communication resources is configured for a respective one of the one or more wake-up radios for reception of the wake-up signal; and
transmitting an indication of the configuration to the radio access node.

17. (canceled)

18. (canceled)

19. The method of claim 10, wherein the wake-up signal is further indicative of which of the multiple links are available for wake-up protocol signaling.

20. (canceled)

21. An apparatus for a radio access node configured for transmission to a user device over multiple links, the apparatus comprising controlling circuitry configured to cause:
responsive to data being available for transmission to the user device, determination of which of the multiple links are possible links for transmission of the data;
selection of one or more links of the possible links; and
transmission of a wake-up signal to the user device, wherein the wake-up signal is indicative of the selected one or more links.

22.-24. (canceled)

25. The apparatus of claim 21, wherein the wake-up signal is for indication to the user device of a request to wake up one or more receivers, corresponding to all of the selected one or more links or corresponding to a sub-set of the selected one or more links.

26.-30. (canceled)

31. An apparatus for a user device configured for reception from a radio access node over multiple links, the user device comprising multiple receivers corresponding to the multiple links and one or more wake-up radios, at least one of the one or more wake-up radios being configured to wake up two or more of the multiple receivers, the apparatus comprising controlling circuitry configured to cause:
reception of a wake-up signal from the radio access node, wherein the wake-up signal is indicative of one or more of the multiple links; and
waking up of one or more of the multiple receivers, corresponding to the indicated one or more links.

32. (canceled)

33. The apparatus of claim 31, wherein the controlling circuitry is configured to cause the waking up of one or more of the multiple receivers by causing waking up of receivers corresponding to all of the indicated one or more links or corresponding to a sub-set of the indicated one or more links.

34.-41. (canceled)
